(19) United States
(12) Patent Application Publication
(10) Pub. No.: US 2011/0199335 A1
(43) Pub. Date: Aug. 18, 2011

(54) Determining a Position of an Object Using a Single Camera

(76) Inventors: Bo Li, Parnell (NZ); John David Newton, Te Atatu (NZ)

(21) Appl. No.: 12/704,849

(22) Filed: Feb. 12, 2010

(51) Int. Cl. G06F 3/042

(52) U.S. Cl. 345/175

(57) ABSTRACT

A coordinate detection system can comprise a display screen, a touch surface corresponding the top of the display screen or a material positioned above the screen and defining a touch area, at least one camera outside the touch area and configured to capture an image of space above the touch surface, and a processor executing program code to identify whether an object interferes with the light from the light source. The processor can be configured to carry out a position detection routine by which information about a point, including can be determined using a single camera. The information may comprise an indication of distance from the plane and/or a three-dimensional coordinate for the point.

### TECHNICAL FIELD

The present invention relates to optical position detection systems.

### BACKGROUND

Touch screens can take on forms including, but not limited to, resistive, capacitive, surface acoustic wave (SAW), infrared (IR), and optical.

Infrared touch screens may rely on the interruption of an infrared or other light grid in front of the display screen. The touch frame or opto-matrix frame contains a row of infrared LEDs and photo transistors. Optical imaging for touch screens uses a combination of line-scan cameras, digital signal processing, front or back illumination and algorithms to determine a point of touch. The imaging lenses image the user's finger, stylus or object by scanning along the surface of the display.

### SUMMARY

Objects and advantages of the present subject matter will be apparent to one of ordinary skill in the art upon careful review of the present disclosure and/or practice of one or more embodiments of the claimed subject matter.

Embodiments can include position detection systems that can be used to determine a position of a touch or another position of an object relative to a screen. One embodiment includes a camera or imaging unit with a field of view that includes a reflective plane, such as a display. An object (e.g., a finger, pen, stylus, or the like) can be reflected in the reflective plane. Using data from the camera, a processing unit can project a first line from the camera to a tip (or another recognized point) of the object and project a second line from the camera origin to the reflection of the tip (or other recognized) point. As the object moves toward the reflective plane, the first and second lines move toward convergence. Thus, the processing unit can determine that a touch event has occurred when the lines merge. Additionally, a distance from the reflective plane may be determined based on the relative arrangement of the first and second lines.

Some embodiments utilize projection information along with information regarding the relative orientation of the reflective plane and imaging plane of the camera to determine a three-dimensional coordinate for the point using data from a single camera.

These illustrative embodiments are mentioned not to limit or define the limits of the present subject matter, but to provide examples to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the following appended figures, in which use of like reference numerals in different features is intended to illustrate like or analogous components.

FIG. 1 is a diagrammatic illustration of a front view of an embodiment of a touch screen.

FIG. 1a is an illustration of a cross sectional view through X-X of FIG. 1.

FIG. 1b is an illustration of front illumination of an embodiment of a touch screen.

FIG. 2 is an illustration of the mirroring effect in an embodiment of a touch screen.

FIG. 2a is a block diagram of the filter implementation an embodiment of a touch screen.

FIG. 2b is a diagrammatic illustration of the pixels seen by an area camera and transmitted to the processing module in an embodiment of a touch screen.

FIG. 3 is a block diagram of the system of an embodiment of a touch screen.

FIG. 4 is a side view of the determination of the position of an object using the mirrored signal in an embodiment of a touch screen.

FIG. 4a is top view of the determination of the position of an object using the mirrored signal in an embodiment of a touch screen.

FIG. 5 is an illustration of the calibration in an embodiment of a touch screen.

FIG. 6 is a graph representing in the frequency domain the output from the imager in the processing module in an embodiment of a touch screen.

FIG. 6a is a graph representing in the frequency domain the filters responses on the signal from the imager in an embodiment of a touch screen.

FIG. 6b is a graph representing in the frequency domain the separation of the object from the background after two types of filtering in an embodiment of a touch screen.

FIG. 7 is an illustration of a front view of the alternate embodiment of a touch screen.

FIG. 7a is an illustration of a cross sectional view through X-X of the alternate embodiment of a touch screen.

FIG. 7b is an illustration of rear illumination of the alternate embodiment of a touch screen.

FIG. 7c is an illustration of rear illumination controlling the sense height of the alternate embodiment.

FIG. 7d is a diagrammatic illustration of the pixels seen by a line scan camera and transmitted to the processing module in the alternate embodiment.

FIG. 8 is a graph representing simple separation of an object from the background in the alternate embodiment.

FIG. 9a shows a two section backlight driven by two wires.

FIG. 9b shows a twelve section backlight driven by 4 wires.

FIG. 9c shows a piece of distributed shift register backlight.

FIGS. 10 and 11 each show an embodiment of a position detection system featuring a single camera.

FIG. 12 generally illustrates a representation of an object as used by a processing unit of a position detection system.

FIGS. 12A-12E show various aspects of the geometry of a surface, reference points, a camera, and a point whose position is to be found.

FIG. 13 is a flowchart showing steps in an exemplary method for 3-D coordinate detection using a single camera.

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made without departing from the scope or spirit of the disclosure and claims. For instance, features illustrated or described as part of one embodiment may be used on another embodiment to yield still further embodiments. Thus, it is intended that the present disclosure includes any modifications and variations as come within the scope of the appended claims and their equivalents.

Presently-disclosed embodiments include position detection systems including, but not limited to, touch screens. In an illustrative embodiment, the optical touch screen uses front illumination and is comprised of a screen, a series of light sources, and at least two area scan cameras located in the same plane and at the periphery of the screen. In another embodiment, the optical touch screen uses backlight illumination; the screen is surrounded by an array of light sources located behind the touch panel which are redirected across the surface of the touch panel. At least two line scan cameras are used in the same plane as the touch screen panel. The signal processing improvements created by these implementations are that an object can be sensed when in close proximity to the surface of the touch screen, calibration is simple, and the sensing of an object is not effected by the changing ambient light conditions, for example moving lights or shadows.

In additional embodiments, a coordinate detection system is configured to direct light through a touch surface, with the touch surface corresponding to the screen or a material above the screen.

A block diagram of a general touch screen system 1 is shown in FIG. 3. Information flows from the cameras 6 to the video processing unit and computer, together referred to as the processing module 10. The processing module 10 performs many types of calculations including filtering, data sampling, and triangulation and controls the modulation of the illumination source 4.

### Front Illumination Touch Screen

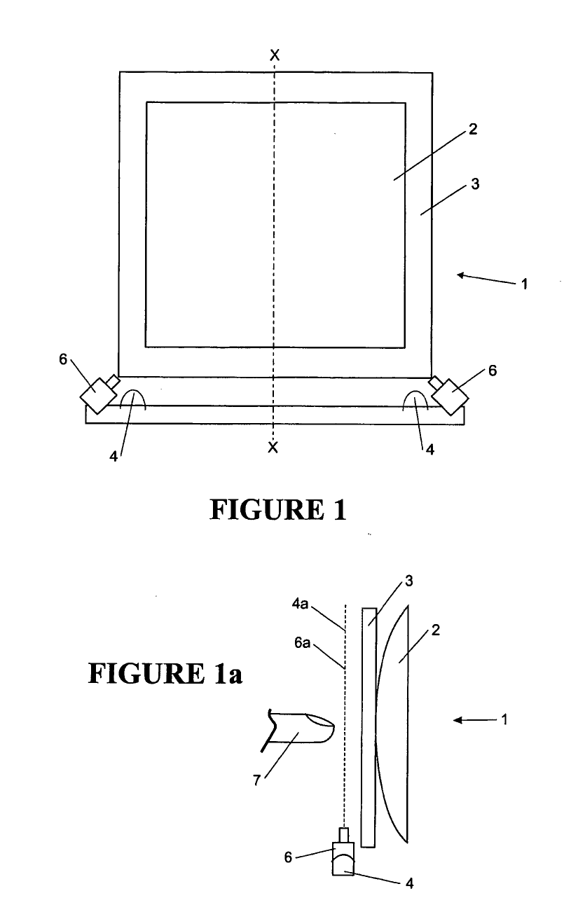

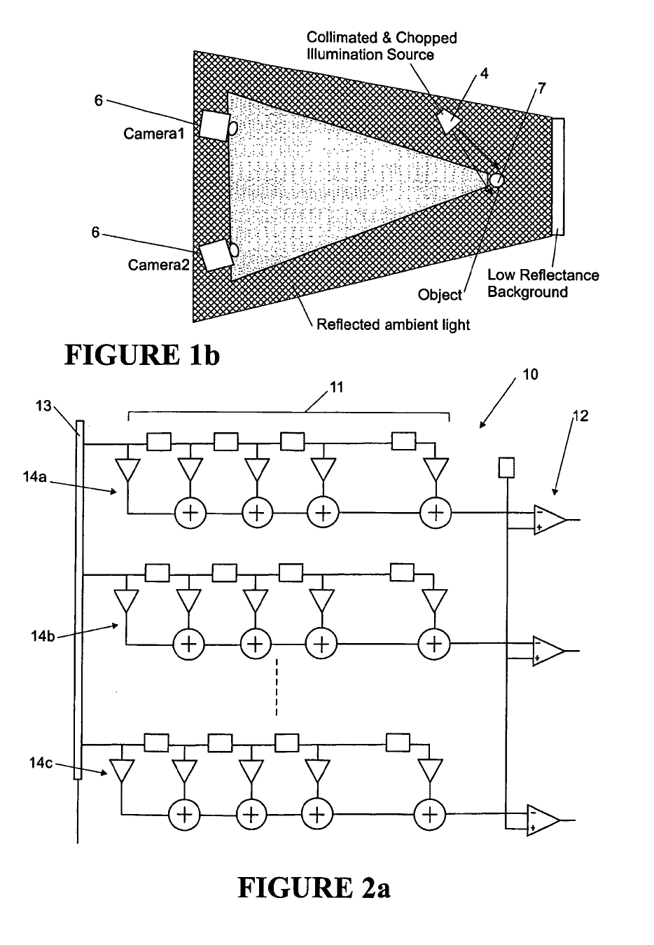

An illustrative embodiment of a position detection system, in this example, a touch screen, is shown in FIG. 1. The touch screen system 1 is comprised of a monitor 2, a touch screen panel 3, at least two lights 4, a processing module (not shown) and at least two area scan cameras 6. The monitor 2, which displays information to the user, is positioned behind the touch screen panel 3. Below the touch screen panel 3 and the monitor 2 are the area scan cameras 6 and light sources 4. The light sources 4 are preferably Light Emitting Diodes (LED) but may be another type of light source, for example, a fluorescent tube. LEDs are ideally used as they may be modulated as required, they do not have an inherent switching frequency. The cameras 6 and LEDs 4 are in the same plane as the touch panel 3.

Referring to FIG. 1a, the viewing field 6a of the area scan camera 6 and the radiation path 4a of the LEDs 4 are in the same plane and parallel to the touch panel 3. When an object 7, shown as a finger, enters into the radiation path 4a, it is illuminated. This is typically known as front panel illumination or object illumination. In FIG. 1b, this principle is again illustrated. Once a finger 7 enters into the radiation field 4a, a signal is reflected back to the camera 6. This indicates that a finger 7 is near to or touching the touch panel 3. In order to determine if the finger 7 is actually touching the touch panel 3, the location of the touch panel 3 must be established. This is performed using another signal, a mirrored signal.

### Mirrored Signal

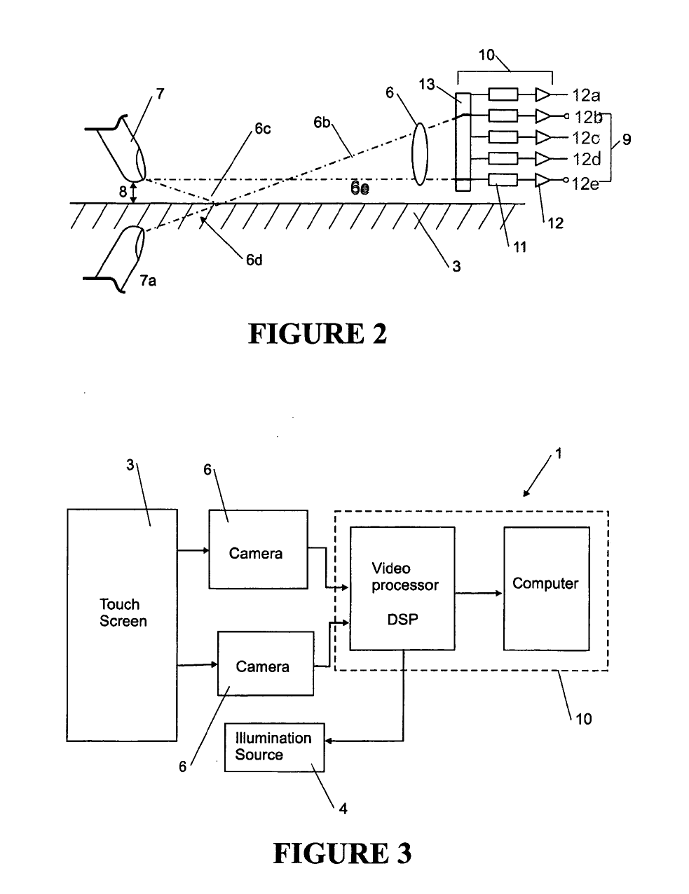

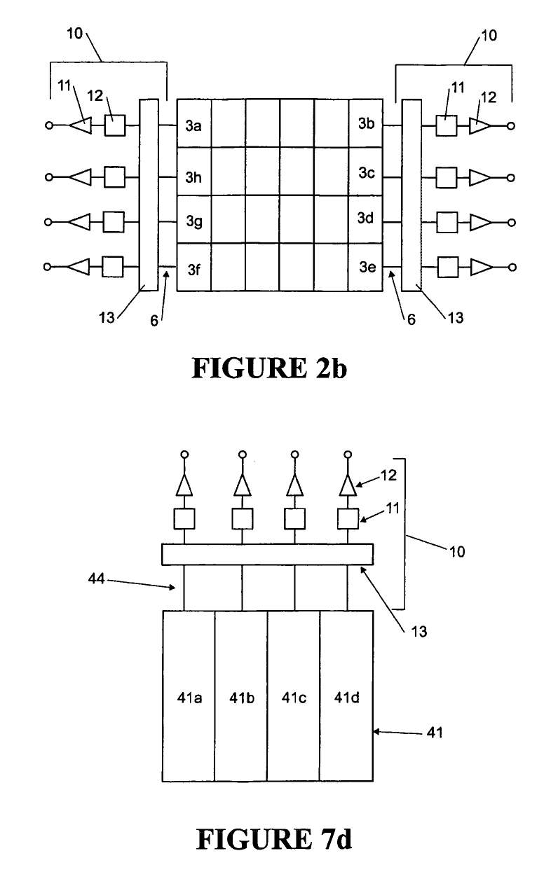

The mirrored signal occurs when the object 7 nears the touch panel 3. The touch panel 3 is preferably made from glass which has reflective properties. As shown in FIG. 2, the finger 7 is positioned at a distance 8 above the touch panel 3 and is mirrored 7a in the touch panel 3. The camera 6 (only shown as the camera lens) images both the finger 7 and the reflected image 7a. The image of finger 7 is reflected 7a in panel 3; this can be seen through the field lines 6b, 6c and virtual field line 6d. This allows the camera 6 to image the reflected 7a image of the finger 7. The data produced from the camera 6 corresponds to the position of the field lines 6e, 6b as they enter the camera 6. This data is then fed into a processing module 10 for analysis.

A section of the processing module 10 is shown in FIG. 2a. Within the processing module 10 is a series of scanning imagers 13 and digital filters 11 and comparators 12 implemented in software. There are a set number of pixels on the touch panel, for example 30,000 pixels. These may be divided up into 100 columns of 300 pixels. The number of pixels may be more or less than the numbers used, the numbers are used for example only. In this situation, there are 30,000 digital filters 11 and comparators 12, broken up into 100 columns of 300 pixels, this forms a matrix similar to the matrix of pixels on the monitor 2. A representation of this is shown in FIG. 2a as one column is serviced by one image scanner 13 and three sets 14a, 14b, 14c of digital filters 11 and comparators 12, this allows information from three pixels to be read. A more illustrated example of this matrix is shown in FIG. 2b. Eight pixels 3a-3h are connected, in groups of columns, to an image scanner 13 that is subsequently connected to a filter 11 and a comparator 12 (as part of the processing module 10). The numbers used in FIG. 2b are used for illustration only; an accurate number of pixels could be greater or less in number. The pixels shown in this diagram may not form this shape in the panel 3, their shape will be dictated by the position and type of camera 6 used.

Referring back to FIG. 2, finger 7 and mirrored finger 7a activates at least two pixels; two pixels are used for simplicity. This is shown by the field lines 6e and 6b entering the processing module 10. This activates the software so the two signals pass through a digital filter 11 and a comparator 12 and results in a digital signal output 12a-12e. The comparator 12 compares the output from the filter 11 to a predetermined threshold value. If there is a finger 7 detected at the pixel in question, the output will be high, otherwise it will be low.

The mirrored signal also provides information about the position of the finger 7 in relation to the cameras 6. It can determine the height 8 of the finger 7 above the panel 3 and its angular position. The information gathered from the mirrored signal is enough to determine where the finger 7 is in relation to the panel 3 without the finger 7 having to touch the panel 3.

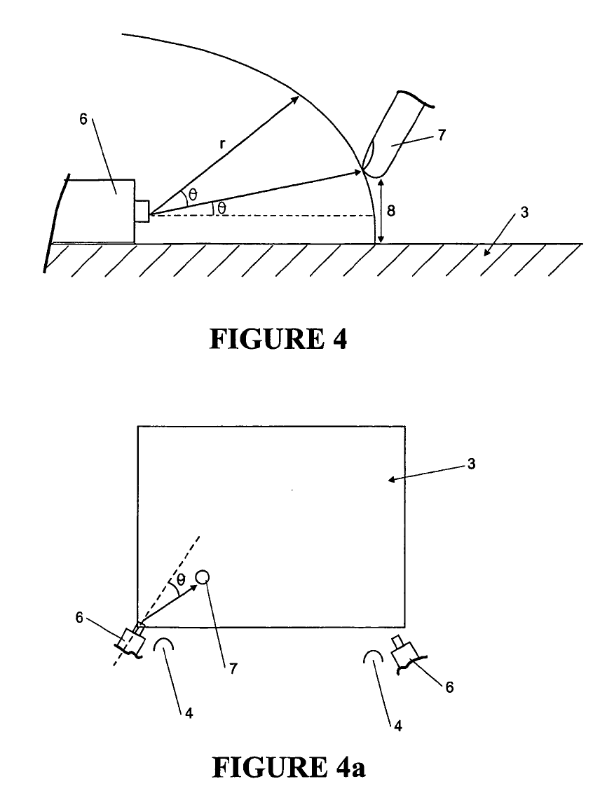

FIGS. 4 and 4a show the positional information that is able to be obtained from the processing of the mirrored signal. The positional information is given in polar co-ordinates. The positional information relates to the height of the finger 7, and the position of the finger 7 over the panel 3.

Referring again to FIG. 2, the height that the finger 7 is above the panel 3 can be seen in the distance between the outputs 12a-12e. In this example the finger 7 is a height 8 above the panel 3 and the outputs 12b and 12e are producing a high signal. The other outputs 12a, 12d are producing a low signal. It has been found that the distance 9 between the high outputs 12b, 12e is twice as great as the actual height 8 of the finger above the panel 3.

### Modulating

The processing module 10 modulates and collimates the LEDs 4 and sets a sampling rate. The LEDs 4 are modulated, in the simplest embodiment the LEDs 4 are switched on and off at a predetermined frequency. Other types of modulation are possible, for example modulation with a sine wave. Modulating the LEDs 4 at a high frequency results in a frequency reading (when the finger 7 is sensed) that is significantly greater than any other frequencies produced by changing lights and shadows. The modulation frequency is greater than 500 Hz but no more than 10 kHz.

### Sampling

The cameras 6 continuously generate an output, which due to data and time constraints is periodically sampled by the processing module 10. In an illustrative embodiment, the sampling rate is at least two times the modulation frequency; this is used to avoid aliasing.

The modulation of the LEDs and the sampling frequency does not need to be synchronised.

### Filtering

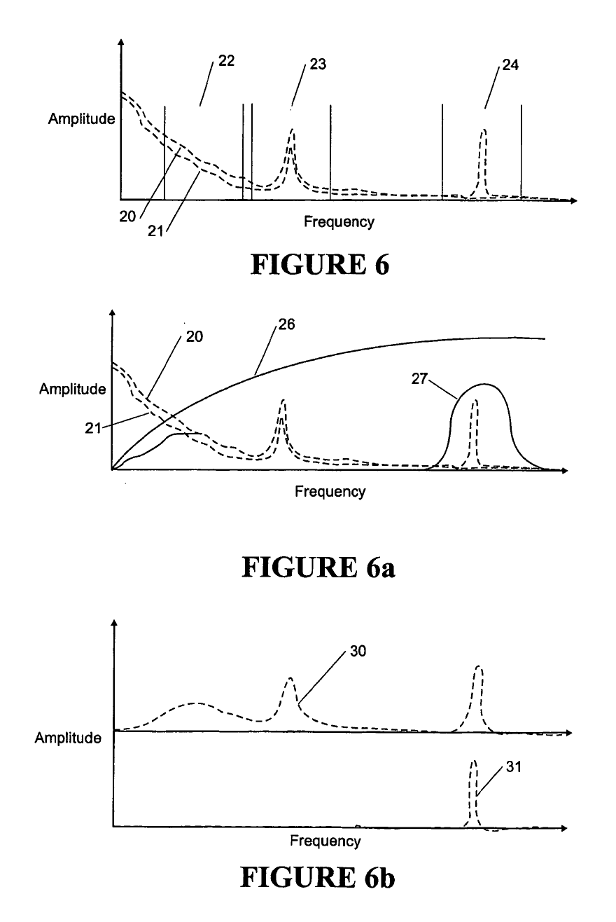

The output in the frequency domain from the scanning imager 13 is shown in FIG. 6. In FIG. 6, there are two typical graphs, one showing when there is no object being sensed 21 and one showing when a finger is sensed 20. In both graphs there is a region of movement of shadows 22 at approximately 5 to 20 Hz, and an AC mains frequency region 23 at approximately 50 to 60 Hz.

In one embodiment, when there is not object in the field of view, no signal is transmitted to the area camera so there are no other peaks in the output. When an object is in the field of view, there is a signal 24 corresponding to the LED modulated frequency, for example 500 Hz. The lower unwanted frequencies 22, 23 can be removed by various forms of filters. Types of filters can include comb, high pass, notch, and band pass filters.

In FIG. 6a the output from the image scanner is shown with a couple of different filter responses 26, 27 being applied to the signal 20. In a simple implementation a 500 Hz comb filter 26 may be implemented (if using a 500 Hz modulation frequency). This will remove only the lowest frequencies. A more advanced implementation would involve using a band pass 27 or notch filter. In this situation, all the data, except the region where the desired frequency is expected, is removed. In FIG. 6a this is shown as a 500 Hz narrow band filter 27 applied to the signal 20 with a modulation frequency of 500 Hz. These outputs 30, 31 from the filters 26, 27 are further shown in FIG. 6b. The top graph shows the output 30 if a comb filter 26 is used while the bottom graph shows the output 31 when a band filter 27 is used. The band filter 27 removes all unwanted signals while leaving the area of interest.

Once the signal has been filtered and the signal in the area of interest identified, the resulting signal is passed to the comparators to be converted into a digital signal and triangulation is performed to determine the actual position of the object. Triangulation techniques are disclosed in U.S. Pat. No. 5,534,917 and U.S. Pat. No. 4,782,328, which are each incorporated by reference herein.

### Calibration

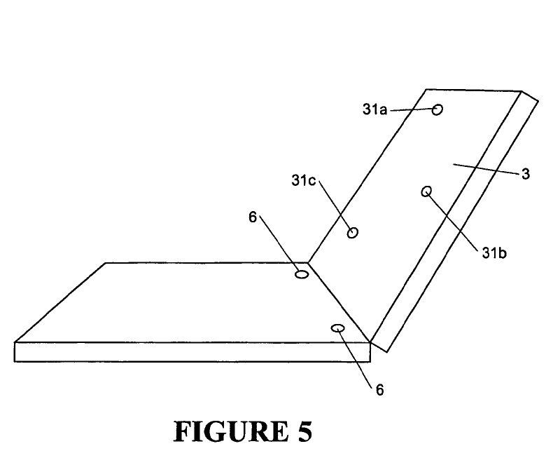

Some embodiments can use quick and easy calibration that allows the touch screen to be used in any situation and moved to new locations, for example if the touch screen is manufactured as a lap top. Calibration involves touching the panel 3 in three different locations 31a, 31b, 31c, as shown in FIG. 5; this defines the touch plane of the touch panel 3. These three touch points 31a, 31b, 31c provide enough information to the processing module (not shown) to calculate the position and size of the touch plane in relation to the touch panel 3. Each touch point 31a, 31b, 31c uses both mirrored and direct signals, as previously described, to generate the required data. These touch points 31a, 31b, 31c may vary around the panel 3, they need not be the actual locations shown.

### Back Illumination Touch Screen

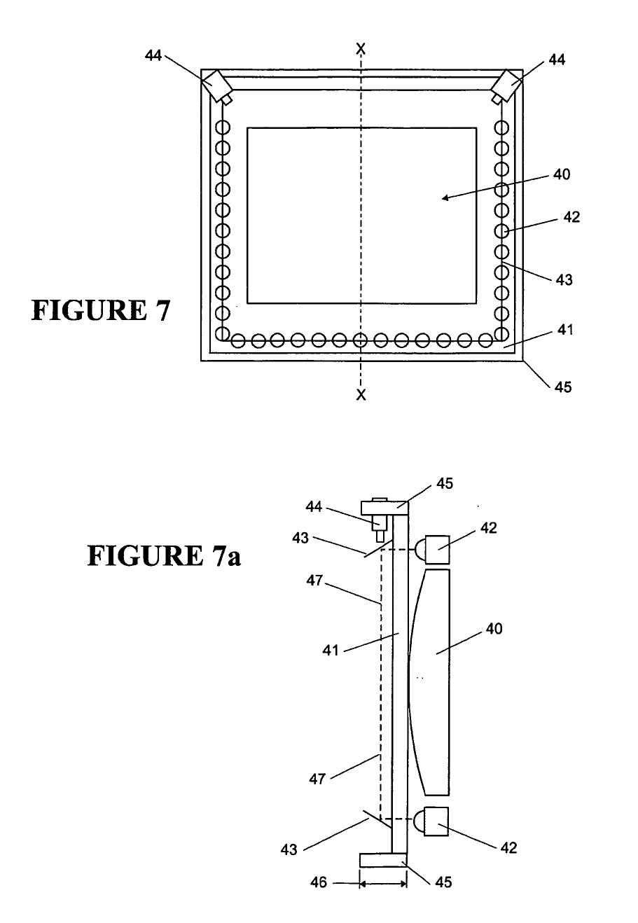

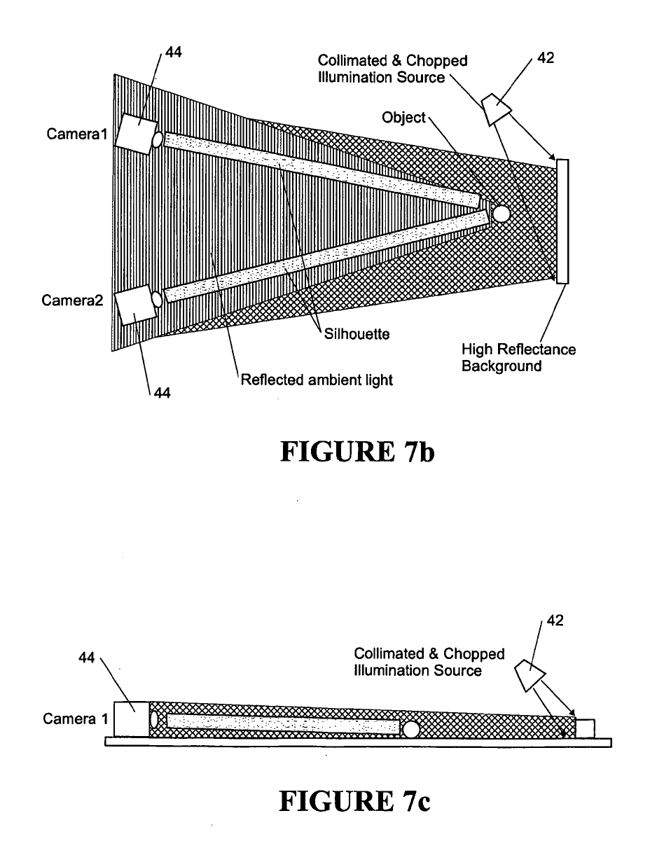

FIG. 7 shows another embodiment of a touch screen. As in previous examples, the monitor 40 is behind the touch panel 41 and around the sides and the lower edge of the panel 41 is an array of lights 42. These point outwards towards the user and are redirected across the panel 41 by a diffusing plate 43. The array of lights 42 consists of numerous Light Emitting Diodes (LEDs). The diffusing plates 43 are used redirect and diffuse the light emitted from the LEDs 42 across the panel 41. At least two line-scan cameras 44 are placed in the upper two corners of the panel 3 and are able to image an object. The cameras 44 can be alternately placed at any position around the periphery of the panel 41. Around the periphery of the touch panel 41 is a bezel 45 or enclosure. The bezel 45 acts as a frame that stops the light radiation from being transmitted to the external environment. The bezel 45 reflects the light rays into the cameras 44 so a light signal is always read into the camera 44 when there is no object near the touch panel 41.

Alternately, the array of lights 42 may be replaced with cold cathode tubes. When using a cold cathode tube, a diffusing plate 43 is not necessary as the outer tube of the cathode tube diffuses the light. The cold cathode tube runs along the entire length of one side of the panel 41. This provides a substantially even light intensity across the surface of the panel 41. Cold cathode tubes are not preferably used as they are difficult and expensive to modify to suit the specific length of each side of the panel 41. Using LED's allows greater flexibility in the size and shape of the panel 41.

The diffusing plate 43 is used when the array of lights 42 consists of numerous LED's. The plate 43 is used to diffuse the light emitted from an LED and redirect it across the surface of panel 41. As shown in FIG. 7a, the light 47 from the LEDs 42 begins its path at right angles to the panel 41. Once it hits the diffusing plate 43, it is redirected parallel to the panel 41. The light 47 travels slightly above the surface of the panel 41 so to illuminate the panel 41. The light 47 is collimated and modulated by the processing module (not shown) as previously described.

Referring to FIG. 7a, the width 46 of the bezel 45 can be increased or decreased. Increasing the width 46 of the bezel 45 increases the distance at which an object can be sensed. Similarly, the opposite applies to decreasing the width 10 of the bezel 45. The line scan cameras 44 consists of a CCD element, lens and driver control circuitry. When an image is seen by the cameras 44 a corresponding output signal is generated.

Referring to FIGS. 7b and 7c, when the touch screen is not being used, i.e. when there is no user interaction or input, all the light emitted from the array of lights 42 is transmitted to the line-scan cameras 44. When there is user input, i.e. a user selects something on the screen by touching it with their finger; a section of the light being transmitted to the camera 44 is interrupted. Through calculations utilizing triangulation algorithms with the outputted data from the camera 44, the location of the activation can be determined.

The line scan cameras 44 can read two light variables, namely direct light transmitted from the LED's 42 and reflected light. The method of sensing and reading direct and mirrored light is similar to what has been previously described, but is simpler as line scan cameras can only read one column from the panel at once; it is not broken up into a matrix as when using an area scan camera. This is shown in FIG. 7d where the panel 41 is broken up into sections 41a-41d (what the line scan camera can see). The rest of the process has been described previously. The pixels shown in this diagram may not form this shape in the panel 41, their shape will be dictated by the position and type of camera 44 used.

In the alternate embodiment, since the bezel surrounds the touch panel, the line scan cameras will be continuously reading the modulated light transmitted from the LEDs. This will result in the modulated frequency being present in the output whenever there is no object to interrupt the light path. When an object interrupts the light path, the modulated frequency in the output will not be present. This indicates that an object is in near to or touching the touch panel. The frequency present in the output signal is twice the height (twice the amplitude) than the frequency in some embodiments. This is due to both signals (direct and mirrored) being present at once.

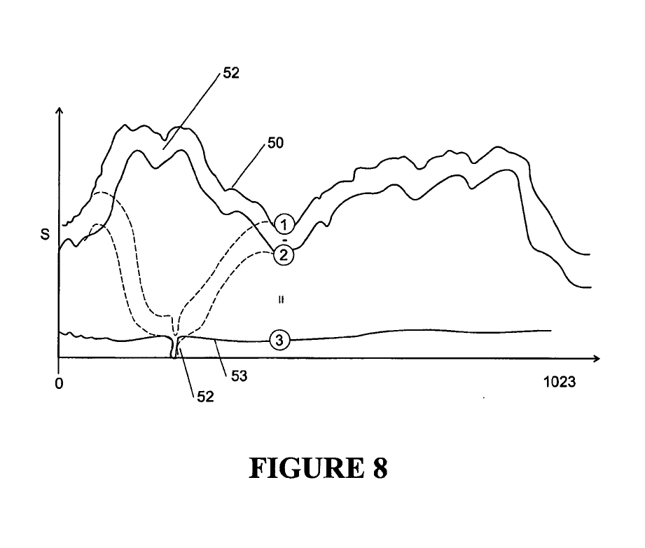

In a further alternate embodiment, shown in FIG. 8, the output from the camera is sampled when the LEDs are modulating on and off. This provides a reading of ambient light plus backlight 50 and a reading of ambient light alone 51. When an object interrupts the light from the LEDs, there is a dip 52 in the output 50. As ambient light varies a lot, it is difficult to see this small dip 52. For this reason, the ambient reading 51 is subtracted from the ambient and backlight reading 50. This results in an output 54 where the dip 52 can be seen and thus simple thresholding can be used to identify the dip 52.

Calibration of this alternate embodiment is performed in the same manner as previously described but the touch points 31a, 31b, 31c (referring to FIG. 5) cannot be in the same line, they must be spread about the surface of the panel 3.

In FIG. 7 the backlight is broken up into a number of individual sections, 42a to 42f. One section or a subset of sections is activated at any time. Each of these sections is imaged by a subset of the pixels of the image sensors 44. Compared to a system with a single backlight control, the backlight emitters are operated at higher current for shorter periods. As the average power of the emitter is limited, the peak brightness is increased. Increased peak brightness improves the ambient light performance.

The backlight switching may advantageously be arranged such that while one section is illuminated, the ambient light level of another section is being measured by the signal processor. By simultaneously measuring ambient and backlit sections, speed is improved over single backlight systems.

The backlight brightness is adaptively adjusted by controlling LED current or pulse duration, as each section is activated so as to use the minimum average power whilst maintaining a constant signal to noise plus ambient ratio for the pixels that view that section.

Control of the plurality of sections with a minimum number of control lines can be achieved in one of several ways.

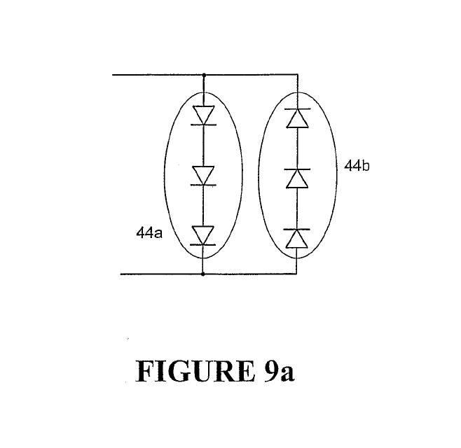

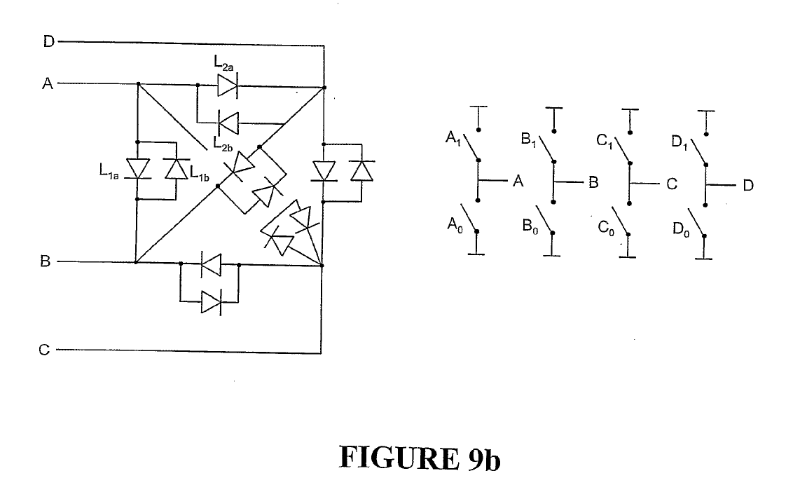

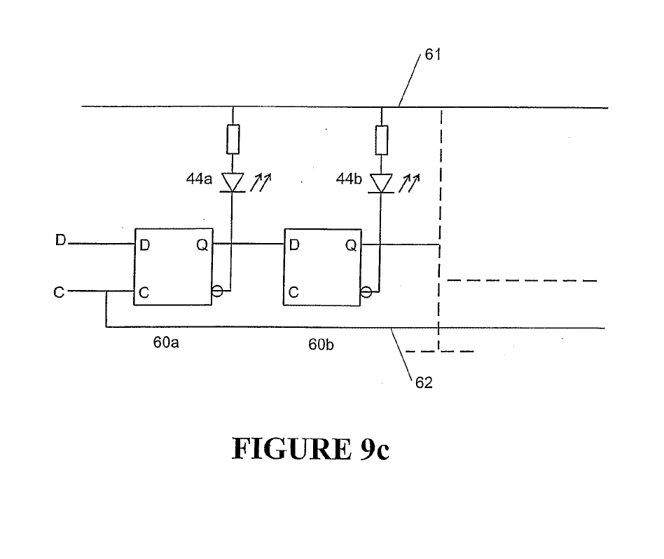

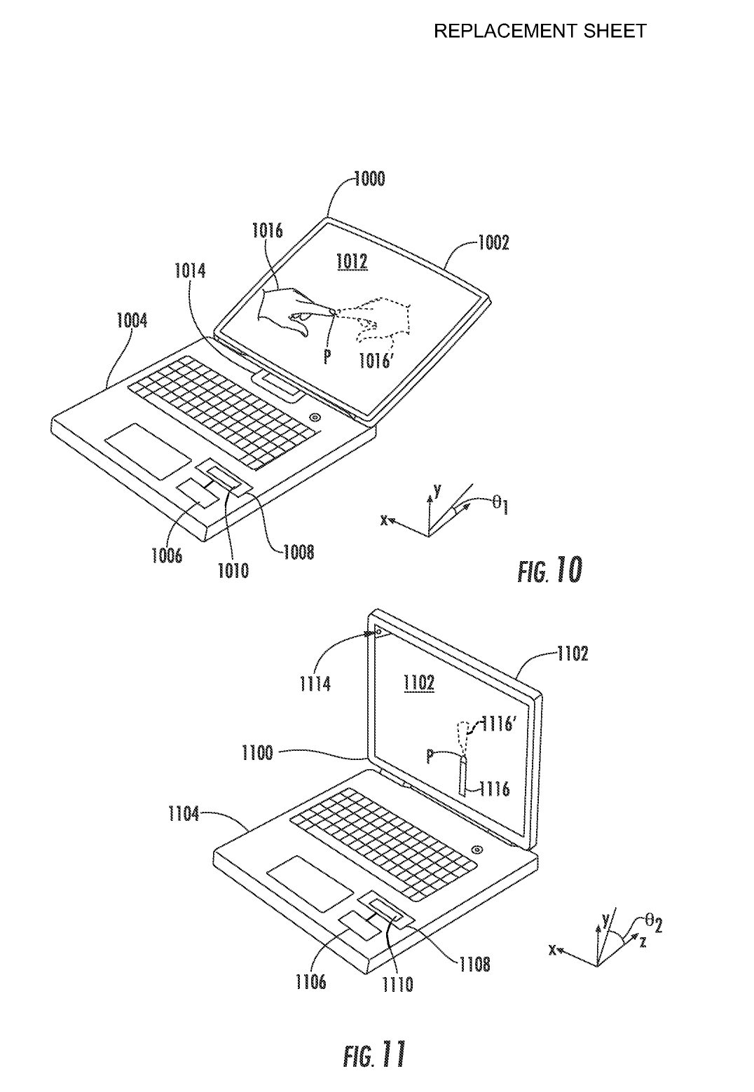

For example, in a first implementation of a two section backlight the two groups of diodes 44a, 44b can be wired antiphase and driven with bridge drive as shown in FIG. 9a.

In a second implementation with more than two sections, diagonal bridge drive is used. In FIG. 9b, 4 wires are able to select 1 of 12 sections, 5 wires can drive 20 sections, and 6 wires drive 30 sections.

In a third implementation shown in FIG. 9c, for a large number of sections, a shift register 60 is physically distributed around the backlight, and only two control lines are required.

X-Y multiplexing arrangements are well known in the art. For example an 8+4 wires are used to control a 4 digit display with 32 LED's. FIG. 9b shows a 4 wire diagonal multiplexing arrangement with 12 LEDs. The control lines A, B, C, D are driven by tristate outputs such as are commonly found at the pins of microprocessors such as the Microchip PIC family. Each tristate output has two electronic switches which are commonly mosfets. Either or neither of the switches can be turned on. To operate led L1a, switches A1 and B0 only are enabled. To operate L1B, A0 and B1 are operated. To operate L2a, A1 and D0 are enabled, and so on. This arrangement can be used with any number of control lines, but is particularly advantageous for the cases of 4, 5, 6 control lines, where 12, 20, 30 LEDs can be controlled whilst the printed circuit board tracking remains simple. Where higher control numbers are used it may be advantageous to use degenerate forms where some of the possible LEDs are omitted to ease the practical interconnection difficulties.

The diagonal multiplexing system has the following features it is advantageous where there are 4 or more control lines; it requires tri-state push-pull drivers on each control line; rather than using an x-y arrangement of control lines with led's at the crossings, the arrangement is represented by a ring of control lines with a pair of antiphase LED's arranged on each of the diagonals between the control lines. Each LED can be uniquely selected, and certain combinations can also be selected; and it uses the minimum possible number of wires where emc filtering is needed on the wires there is a significant saving in components.

The above examples referred to various illumination sources and it should be understood that any suitable radiation source can be used. For instance, light emitting diodes (LEDs) may be used to generate infrared (IR) radiation that is directed over one or more optical paths in the detection plane. However, other portions of the EM spectrum or even other types of energy may be used as applicable with appropriate sources and detection systems.

Several of the above examples were presented in the context of a position detection system comprising touch-enabled display. However, it will be understood that the principles disclosed herein could be applied even in the absence of a display screen when the position of an object relative to an area is to be tracked. For example, the touch area may feature a static image or no image at all.

Additionally, in some embodiments a “touch detection” system may be more broadly considered a “position detection” system since, in addition to or instead of detecting touch of the touch surface, the system may detect a position/coordinate above the surface, such as when an object hovers but does not touch the surface. Thus, the use of the terms “touch detection,” “touch enabled,” and/or “touch surface” is not meant to exclude the possibility of detecting hover-based or other non-touch input.

### Position Detection Using a Single Camera

In some embodiments, a position detection system can comprise a camera, the camera positioned to image light traveling in a detection space above a surface of a display device or another at least partially reflective surface, along with light reflected from the surface. One or more light sources (e.g., infrared sources) may be used, and can be configured to direct light into the detection space. However, the system could be configured to utilize ambient light or light from a display device.

The camera can define an origin of a coordinate system, and a controller (e.g., a processor of a computing system) can be configured to identify a position of one or more objects in the space using (i) light reflected from the object directly to the camera and (ii) light reflected from the object, to the surface, and to the camera (i.e., a mirror image of the object).

The position can be identified based on finding an orientation of the surface relative to an image plane of the camera and by projecting points in the image plane of the camera to points in the detection space and a virtual space corresponding to a reflection of the detection space. In some embodiments, as will be noted below, the controller is configured to correct light detected using the camera to reduce or eliminate the effect of ambient light. For instance, the controller may be configured to correct light detected using the camera by modulating light from the light source using techniques noted earlier or other modulation techniques.

FIGS. 10 and 11 each show an exemplary embodiment of a position detection system featuring a single camera. In system 1000 of FIG. 10, the camera 1014 is remote from a body 1002 featuring the touch surface while in system 1100 of FIG. 11, the camera 114 is positioned on the body 1102 carrying the display. In these examples, the touch surface corresponds to the display or a material above the display, though the techniques could be applied to a touch surface not used as a display. Other embodiments feature still further camera locations. Generally, the camera can comprise any suitable sensing technology, such as an area sensor based on CMOS or other light detection technology.

In both examples, the coordinate detection system comprises a second body 1004/1104 featuring a processing unit 1006/1106 and a computer-readable medium 1008/1108. For example, the processing unit may comprise a microprocessor, a digital signal processor, or microcontroller configured to drive components of the coordinate detection system and detect input based on one or more program components.

Exemplary program components 1010/1110 are shown to illustrate one or more applications, system components, or other programming that cause the processing unit to determine a position of one or more objects in accordance with the embodiments herein. The program components may be embodied in RAM, ROM, or other memory comprising a computer-readable medium and/or by may be comprise stored code (e.g., accessed from a disk). The processor and memory may be part of a computing system utilizing the coordinate detection system as an input device, or may be part of a coordinate detection system that provides position data to another computing system. For example, in some embodiments, the position calculations are carried out by a digital signal processor (DSP) that provides position data to a computing system (e.g., a notebook or other computer) while in other embodiments the position data is determined directly by the computing system by driving light sources and reading the camera sensor.

Systems 1000 and/or 1100 may each, for example, comprise a laptop, tablet, or “netbook” computer. However, other examples may comprise a mobile device (e.g., a media player, personal digital assistant, cellular telephone, etc.), or another computing system that includes one or more processors configured to function by program components. A hinged form factor is shown here, but the techniques can be applied to other forms, e.g., tablet computers and devices comprising a single unit, surface computers, televisions, kiosks, etc.

In FIG. 10, an object 1016 (depicted as a finger) is shown touching touch surface 1012 at a touch point P. A mirror image 1016′ of object 1016 is visible in touch surface 1012. In FIG. 11, a stylus 1116 touches surface 1112 at touch point P, and a mirror image 1112′ is visible. As will be explained below, a coordinate detection system can use data regarding the sensed object and its mirror image, along with additional data, to determine a position of the sensed object. The position may indicate a touch point P or may indicate a coordinate above the surface, such as when a hover-based input gesture is being provided. The coordinate data can be provided to other program components to determine appropriate responses (e.g., performing an action in response to a touch to an on-screen control, tracking a position over time, etc.).

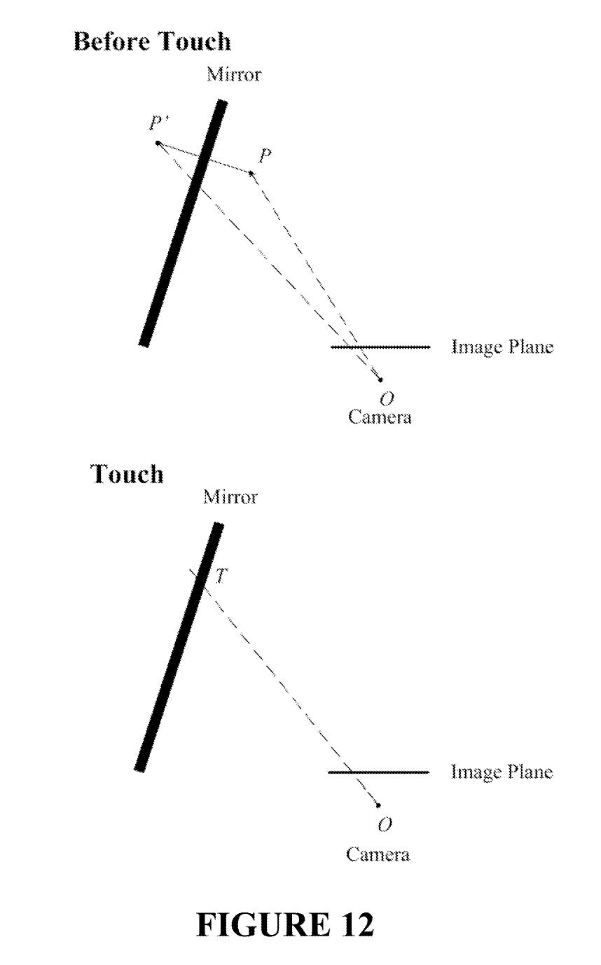

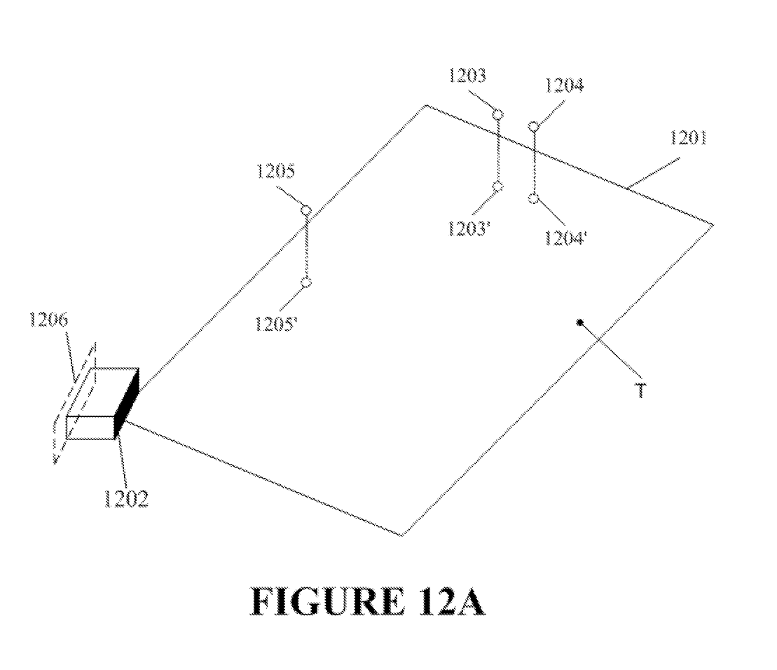

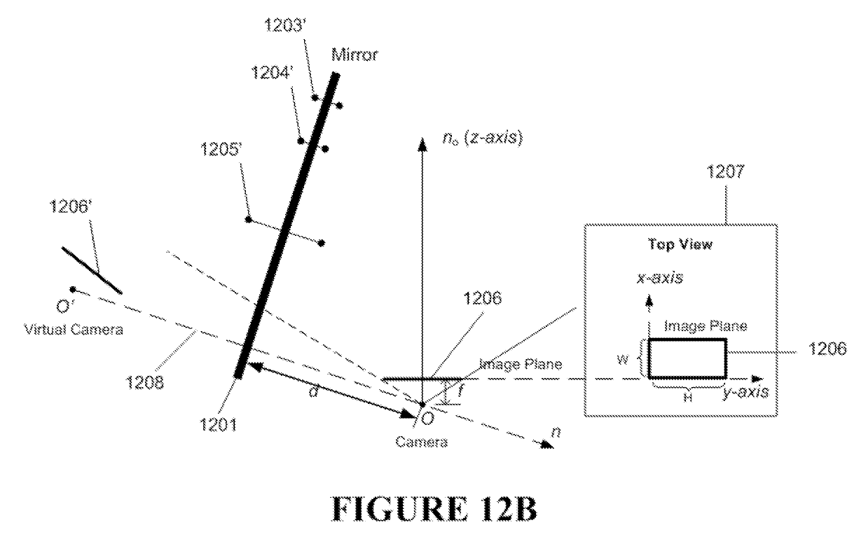

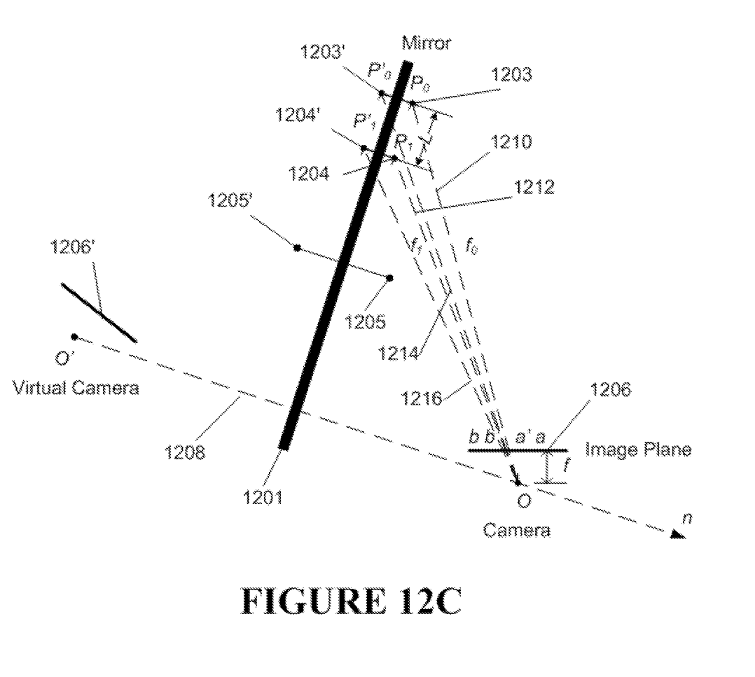

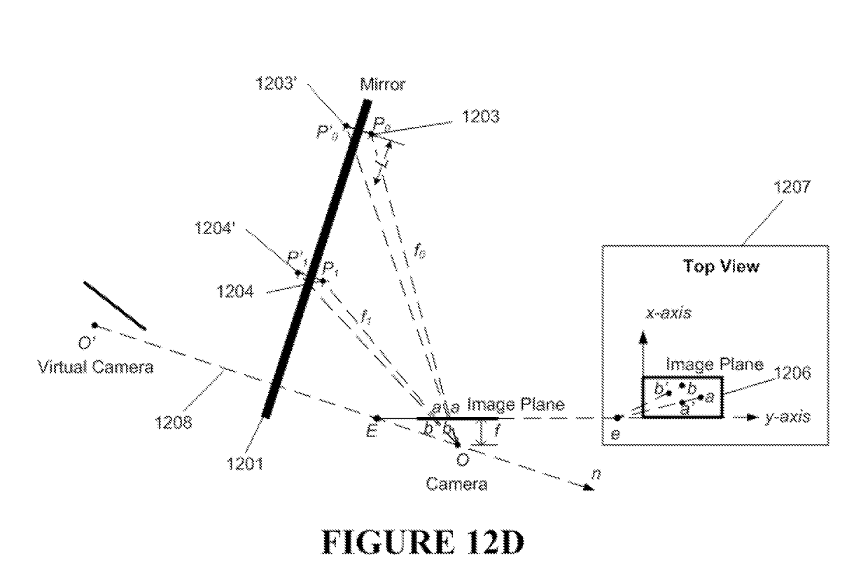

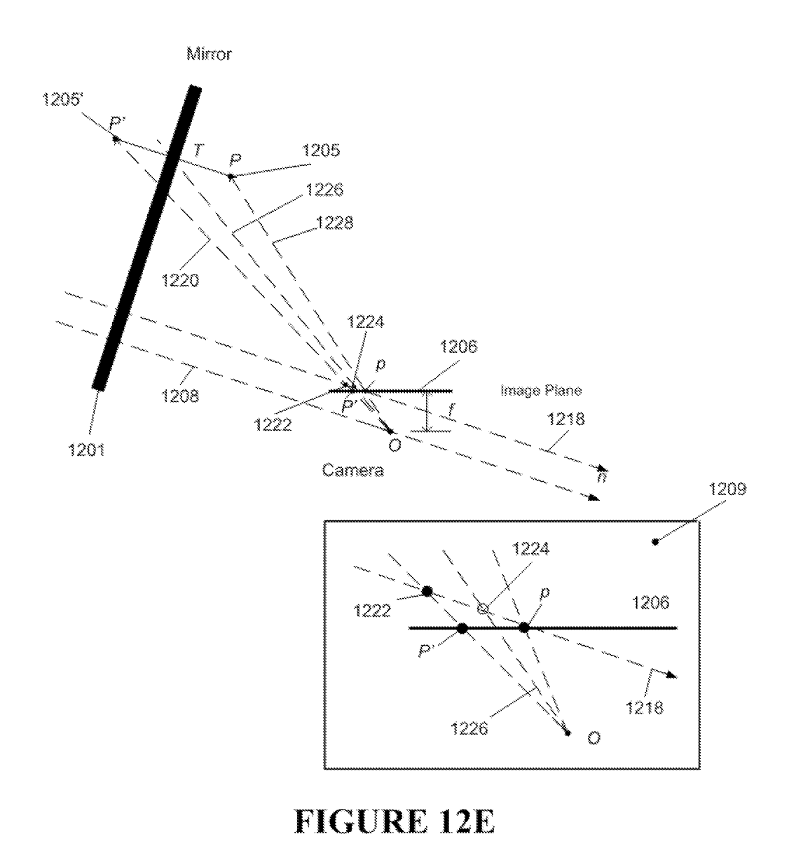

FIG. 12 generally illustrates a representation of an object as used by a processing unit of a position detection system. The camera includes a field of view that includes a reflective plane, such as a display, indicated here as a mirror. In this example, the camera is represented as an origin O and an image plane. An object (e.g., a finger, pen, stylus, or the like) can be reflected in plane. Using data from the camera, a processing unit can project a first line OP from the camera origin O to a point P that corresponds to a recognized point or feature of the object, such as a fingertip, end of a stylus, or the like. The processing unit can also project a second line OP′ from the camera origin O to the reflection P′ of recognized point P.

FIG. 12 shows a “Before Touch” and a “Touch” condition. As can be appreciated, as the object moves toward the reflective plane, the first line OP and second line OP′ move toward convergence, represented in the “Touch” condition as a line OT. Thus, the processing unit can determine that a touch event has occurred when the lines merge and can determine other information about the position of point P based on the degree of convergence between the lines (e.g., angle between the lines or another suitable expression of how close or far the lines are from converging). For example, a point's distance from the reflective plane may be determined based on the relative arrangement of the first and second lines.

A position detection system can utilize any suitable combination of techniques for determining other coordinates of point P, if such additional coordinates are desired. For example, the line-convergence technique may be used to determine a touch position or distance from a screen while another technique (e.g., triangulation) is used with suitable imaging components to determine other position information for point P. However, as noted above and in further detail below, in some embodiments a full set of coordinates for point P can be determined using data from a single camera or imaging unit.

FIG. 12A shows a generalized view 1200 of a coordinate detection system including a touch surface 1201 and a camera 1202. For example, touch surface 1201 may comprise a display device or material positioned over a display device. Camera 1202 can be interfaced to a controller (not shown), such as a computing system CPU or a DSP of the coordinate detection system. The coordinate detection system can utilize detection data representing reference objects 1203 and 1204 and their mirror images 1203′ and 1204′ as reflected by a top surface T of surface 1201 to determine a relative position of the camera image plane 1206 to touch surface 1201. Based on this information, a coordinate for object 1205 can be determined using detection data representing an image of object 1205 and its mirror image 1205′ as reflected by surface 1201. Camera 1202 can be positioned at any suitable angle or positioned relative to touch surface 1201, and its depiction near the corner is not meant to be limiting.

The reference objects may comprise features visible in the touch surface, such as hinges of a hinged display, protrusions or markings on a bezel, or tabs or other structures on the frame of the display.

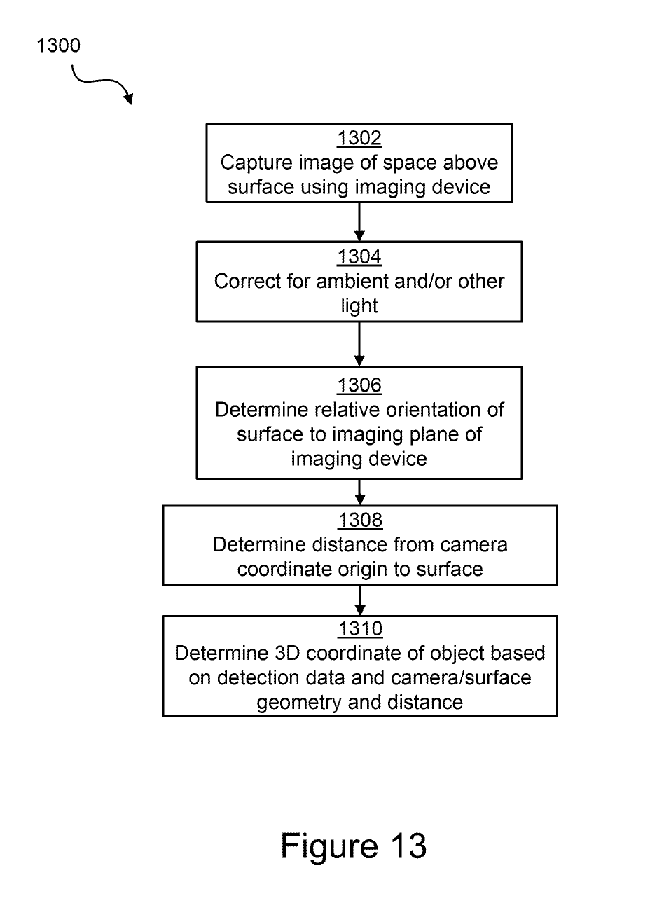

FIG. 13 shows an overall method 1300 for determining a 3D position, and steps thereof will be discussed in conjunction with additional views of FIG. 12. Generally, the position detection routine can be carried out by a processor configured to access data representing known information about the reference points, read the sensor, and then maintain representations of the geometry in memory in order to solve for the 3-D coordinate in accordance with the teachings below or variants thereof.

In the remaining views, points in camera coordinates are represented as using capital letters, with corresponding points in image coordinates represented using the same letters, but lower-case. For instance, a point G in the space above the surface will have a mirror image G′ and image coordinate g. The mirror image will have an image coordinate g′.

Block 1302 represents capturing an image of the space above a surface (e.g., surface 1201) using an imaging device, with the image including at least one point of interest and two known reference points. As indicated at 1304, in some embodiments the routine includes a correction to remove effects of ambient or other light. For instance, in some embodiments, a light source detectable by the imaging device is modulated at a particular frequency, with light outside that frequency filtered out. As another example, modulation and image capture may be timed relative to one another.

FIG. 12B shows another view of coordinate detection system 1200, in this view looking down along an edge of surface 1201 and along the edge of image plane 1206. Space above top surface T is on the right side of the page relative to surface 1201 and a virtual space is to the left. In this example, camera 1202 defines origin O, which is separated from image plane 1206 by the focal length f of the camera. Additionally, inset 1207 shows a view looking along the z-axis, which is defined by vector nₒ and is normal to image plane 1206. In the inset, the width of the sensor in the image plane is shown along the x-axis as W and contains w pixels. The height of the sensor in the image plane is shown along the y-axis as H and contains h pixels.

In this example, the method first determines the relative geometry of the image plane and surface, using data identifying a distance between two reference points and a height of the reference points above the surface. Block 1306 in FIG. 13 represents finding an orientation of the surface relative to an imaging plane of the imaging device, and an example of such a technique is noted below.

Returning to FIG. 12B, to the left of surface 1201, a virtual camera origin is shown at O′ in the virtual space, along with mirror images 1203′, 1204′, and 1205′. Line 1208 between origin O and virtual origin O′ is known as the epipolar line, and being perpendicular to the reflective surface 1201 represents the normal (n) of the surface. The distance from O to the plane of surface 1201 is d, and so the plane of surface 1201 can be represented by

n·x+d=0

where x is all points on surface 1201 (not to be confused with the x in image plane coordinates).

Turning to FIG. 12C, the geometry related to reference points 1203 and 1204 will be discussed. Reference point 1203 can be represented as P₀:

P₀=t₀·f₀

where f₀ is a unit vector from O to P₀ and t₀ is a scaling factor for the vector.

Reference point 1204 can be represented as P₁:

P₁=t₁·f₁

where f₁ is a unit vector from O to P₁ and t₁ is a scaling factor for the vector.

The two-dimensional image coordinates of reference point 1203 (P₀) are represented as a, while the image coordinates of its mirror image 1203′ (P′₀) are represented as a′. For reference point 1204 (P₁) and its mirror image 1204′ (P′₁), the image coordinates are b and b′, respectively. The distance between points 1203 (P₀) and 1204 (P₁) is L, which is known from the configuration of the coordinate detection system in this embodiment. The height of points 1203 (P₀) and 1204 (P₁) above surface 1201 is h₀ and is determined or measured beforehand during setup/configuration of the system.

Turning next to FIG. 12D, the relationships and information above can be used in deriving the orientation of surface 1201. For clarity, point 1205 and its mirror image 1205′ are not shown in FIG. 12D. As described by Steven A. Shafer, vectors from a shadow point to its corresponding occluder point intersect at a single point, which is the vanishing point of a directional light source, or the image of a point light source. The paper “Multiple-view 3D Reconstruction Using a Mirror,” by Hu et al and published as Technical Report 863 by the University of Rochester Computer Science Department, describes how this vanishing point is on the epipolar line between the virtual camera center O′ and camera center O. Turning to FIG. 12D, it can be seen that the intersection between the line aa′ and bb′ is a point e in the image coordinates.

A corresponding point E in camera coordinates can be calculated by:

$$E = ( \frac{W}{w} \cdot e \cdot x , \frac{H}{h} \cdot e \cdot y , f )$$

Because E is the epipolar point, then normalized −E is the normal of the reflective surface 1201:

n=normalized (−E)

with normalized referring to dividing the vector (−E in this example) by its length.

Another aspect of the relative geometry of the image plane and the camera is the distance between the camera and the plane. In FIG. 13, block 1308 represents determining a distance d from the origin to the surface. This information, along with the orientation of the surface, will be used later to determine a 3-D coordinate for an object (point 1205 in these examples).

Returning to FIG. 12D, because reference points 1203 (P₀) and 1204 (P₁) are above surface 1201 by the same height h₀, they lay in the same plane. An equation for a plane going through points 1203 and 1204 and parallel to the mirror is

n·x+(d−h₀)=0

It follows that:

$$\{ \begin{matrix}n \cdot {P}_{0} + ( d - {h}_{0} ) = 0 \\ n \cdot {P}_{1} + ( d - {h}_{0} ) = 0\end{matrix}$$

As noted above,

P₀=t₀·f₀ and P₁=t₁·f₁

Vector f₀ can also be represented in terms of calculating the position of a in camera coordinates (A):

f₀=normalized (A)

Similarly, vector f₁ can also be represented in terms of calculating the position of b in camera coordinates (B):

f₁=normalized (B)

In FIG. 12D, a is the projection of P₀ in the image coordinates, and thus corresponds to point A in camera coordinates. Point B in camera coordinates corresponds to point b in the camera coordinates.

Vectors f₀ and f₁ can be substituted into the plane equation noted above:

$$\{ \begin{matrix}n \cdot {t}_{0} \cdot {f}_{0} + ( d - {h}_{0} ) = 0 \\ n \cdot {t}_{1} \cdot {f}_{1} + ( d - {h}_{1} ) = 0\end{matrix}$$

To yield:

$$\{ \begin{matrix}{t}_{0} = - \frac{d - {h}_{0}}{n \cdot {f}_{0}} \\ {t}_{1} = - \frac{d - {h}_{0}}{n \cdot {f}_{1}}\end{matrix}$$

As noted previously, the distance between points 1203 (P₀) and 1204 (P₁) is known to be L. L can be calculated from

$$\begin{matrix}L = {‖ {P}_{0} - {P}_{1} ‖}_{:} \\ = ‖ \frac{d - {h}_{0}}{n \cdot {f}_{0}} \cdot {f}_{0} - \frac{d - {h}_{0}}{n \cdot {f}_{1}} \cdot {f}_{1} ‖ \\ = ( d - {h}_{0} ) \cdot ‖ \frac{{f}_{0}}{n \cdot {f}_{0}} - \frac{{f}_{1}}{n \cdot {f}_{1}} ‖\end{matrix}$$

And thus an expression for d can be found in terms of h₀, L, f₀, f₁, and n:

$$d = {h}_{0} + \frac{L}{‖ \frac{{f}_{0}}{n \cdot {f}_{0}} - \frac{{f}_{1}}{n \cdot {f}_{1}} ‖}$$

Block 1310 of FIG. 13 represents determining a 3-D coordinate of an object (point 1205 in FIGS. 12A-12E). In some embodiments, the geometry of the mirror relative to the camera can be determined and then 3-D coordinates detected one or more times without re-determining the geometry each time. However, it may be advantageous to repeat steps 1302-1308 in order to account for changes in the relative position of the camera and display.

Turning to FIG. 12E, point 1205 (P) is shown along with its mirror image 1205′ (P′), image plane 1206, and origin O. At this stage, the geometry of reflective surface 1201 is known, and so the 3-D coordinate can be determined, assuming focal length f of the camera is determined. Focal length f can be found using a minimum calibration known to those of skill in the art using known calibration tools or may be provided in specifications for the camera.

As can be seen in FIG. 12E, point 1205 (P) projects to a point p in image plane 1206, while its mirror image projects to a point p′. A line 1218 can be defined paralleling the mirror normal n and passing through point p in image plane 1206. Line 1218 intersects a line 1220 passing through O and p′ (line 1220 also passes through P′) at a point labeled as 1222. A midpoint 1224 between point p and point 1222 along line 1218 can be calculated. Then, a line 1226 can be projected between O and midpoint 1224, which as shown will intersect the plane of surface 1201 at a “touch point” T (although no actual touch may be occurring). A line normal to surface 1201 from touch point T will intersect line 1228 between point P and origin O at point P.

Once point P is defined in terms of an intersection between line TP and line OP, the routine will have sufficient equations that, combined with the information about the geometry of image plane 1206 and surface 1201, can be solved for an actual coordinate value. In practice, additional adjustments to account for optical distortion of the camera (e.g., lens aberrations) can be made, but such techniques should be known to those of skill in the art.

The various systems discussed herein are not limited to any particular hardware architecture or configuration. As was noted above, a computing device can include any suitable arrangement of components that provide a result conditioned on one or more inputs. Suitable computing devices include multipurpose microprocessor-based computer systems accessing stored software, but also application-specific integrated circuits and other programmable logic, and combinations thereof. Any suitable programming, scripting, or other type of language or combinations of languages may be used to implement the teachings contained herein in software.

Embodiments of the methods disclosed herein may be executed by one or more suitable computing devices. Such system(s) may comprise one or more computing devices adapted to perform one or more embodiments of the methods disclosed herein. As noted above, such devices may access one or more computer-readable media that embody computer-readable instructions which, when executed by at least one computer, cause the at least one processor to measure sensor data, project lines, and carry out suitable geometric calculations to determine one or more coordinates.

As an example programming can configure a processing unit of digital signal processor (DSP) or a CPU of a computing system to carry out an embodiment of a method to determine the location of a plane and to otherwise function as noted herein.

When software is utilized, the software may comprise one or more components, processes, and/or applications. Additionally or alternatively to software, the computing device(s) may comprise circuitry that renders the device(s) operative to implement one or more of the methods of the present subject matter.

Any suitable computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices, and the like.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art

What is claimed:

1. A position detection system comprising:
a camera, the camera positioned to image light traveling in a detection space above a surface of a display device and light reflected from the surface, the camera defining an origin of a coordinate system, the surface comprising the top of the display or a material positioned over the display;
a controller, the controller configured to identify a position of an object in the space using (i) light reflected from the object directly to the camera and (ii) a mirror image comprising light reflected from the object, to the surface, and to the camera,
wherein the position is identified based at least in part by:
projecting a first line from the camera origin to a recognized point of the object in the detection space, projecting a second line from the camera to the reflection of the recognized point, the reflection in a virtual space corresponding to a reflection of the detection space, and determining whether the object is touching the surface based on the first and second lines.

2. The position detection system set forth in claim 1, further comprising a light source configured to direct light into the detection space,
wherein the controller is configured to correct light detected using the camera to reduce or eliminate the effect of ambient light.

3. The position detection system set forth in claim 2, wherein the controller is configured to correct light detected using the camera by modulating light from the light source.

4. The position detection system set forth in claim 2, wherein the light source comprises an infrared light source.

5. The position detection system set forth in claim 2, wherein the display comprises a screen of a computer or mobile device.

6. The position detection system set forth in claim 1, wherein identifying comprises:
(a) determining a distance from the origin to the surface and an orientation of the surface relative to an image plane of the camera based on (i) points of light in the image plane corresponding to light imaged by the camera from the two reference points and reflections of the two reference points, (ii) a parameter indicating the distance of the reference points to the surface, and (iii) a parameter indicating a distance between the reference points,
(b) projecting a first line normal to the surface and passing through a first point in the image plane corresponding to detected light from the object,
(c) projecting a second line between the camera origin and a virtual point corresponding to a virtual position of the reflection of the object,
(d) determining an intersection point between the first line and the second line,
(e) determining a midpoint on a line between the intersection point and the first point in the image plane,
(f) projecting a third line from the camera origin through the midpoint to the surface to define a touch point T where the surface intersects the third line,
(g) projecting a fourth line from the origin through the first point, and
(h) projecting a fifth line from touch point T and normal to the mirror surface, wherein the position of the object corresponds to a point at which the fourth and fifth lines intersect.

7. The position detection system set forth in claim 6, further comprising a light source, the light source configured to project light into the space.

8. The position detection system set forth in claim 7, wherein the controller is configured to correct light detected using the camera to reduce or eliminate the effect of ambient light.

9. The position detection system set forth in claim 8, wherein the controller is configured to modulate light from the light source and image light using the camera based on the modulation of the light.

10. The position detection system set forth in claim 6, wherein the light source comprises an infrared light source.

11. The position detection system set forth in claim 6, wherein the reference points correspond to features of the display device or a component into which the display device is incorporated.

12. A method, comprising:
capturing an image using an imaging device defining an image plane, the image including space above an at least partially-reflected surface and a virtual space reflected in the surface;
determining, by a processor, a relative geometry indicating a distance and orientation between the surface and the image plane based on an image of a reference point and a mirror image of the reference point; and
determining a three-dimensional coordinate of an object in the space based on an image of the object and the relative geometry.

13. The method set forth in claim 12, further comprising:
emitting light into the space above the surface, wherein the light is modulated at a modulation frequency falling within a range, and
wherein capturing an image comprises filtering light outside the range.

14. The method set forth in claim 12, wherein the at least partially-reflected surface comprises a display or a material positioned above a display.

15. The method set forth in claim 12, wherein the reference point comprises a feature of the display.

16. The method set forth in claim 12, wherein the display is comprised in a computer or a mobile device.

17. A computer program product comprising a tangible computer-readable medium embodying program code, the program code comprising:
code that configures a computing system to capture an image using an imaging device defining an image plane, the image including space above an at least partially-reflected surface and a virtual space reflected in the surface;
code that configures the computing system to determine, a relative geometry indicating a distance and orientation between the surface and the image plane based on an image of a reference point and a mirror image of the reference point; and
code that configures the computing system to determine a three-dimensional coordinate of an object in the space based on an image of the object and the relative geometry.

18. The computer program product set forth in claim 17, further comprising
code that configures the computing system to cause an emitter to emit light into the space above the surface, the light is modulated at a modulation frequency falling within a range detectable by the imaging device.

19. The computer program product set forth in claim 17, wherein the code that configures the computing system to determine the relative geometry configures the computing system to access data identifying a distance between two reference points and a height of the reference points above the screen.

20. The computer-program product set forth in claim 17, wherein the tangible computer-readable medium comprises at least one of memory of a desktop, laptop, or portable computer, memory of a mobile device, or memory of a digital signal processor.
